(19) United States
(12) Patent Application Publication
(10) Pub. No.: US 2012/0024548 A1
(43) Pub. Date: Feb. 2, 2012

(54) Atomized Fire Apparatus that is Driven by a Single Power

(76) Inventor: Yuan-Huan Chang, Yuanlin Jen (TW)

(21) Appl. No.: 12/894,228

(22) Filed: Sep. 30, 2010

(30) Foreign Application Priority Data
Jul. 27, 2010 (TW) 099214336

(51) Int. Cl. A62C 27/00

(52) U.S. Cl. 169/52

(57) ABSTRACT

A fire apparatus includes a main body, a water tank mounted in the main body, a spray gun mounted on the main body, a hose connected with the water tank and the spray gun, a drive pump connected with the spray gun, a power source mounted on the main body, and a transmission unit connected between the power source and the drive pump. When the power source is disposed at a slow running state during a neutral position, the power of the power source is transmitted by the transmission unit to the drive pump so that the drive pump is driven to pressurize the water tank and the spray gun, and the spray gun sprays atomized water or bubbles to extinguish the fire. Thus, the drive pump is driven by a single power of the power source without needing an external power supply.

### BACKGROUND OF THE INVENTION

1. Field of the Invention

The present invention relates to a fire system and, more particularly, to a fire apparatus that injects atomized water or bubbles to extinguish fires in an atomizing manner.

2. Description of the Related Art

A conventional fire apparatus is mounted on the ceiling and comprises a smoke detector and a water sprinkler. When the smoke detector detects that the fires happen, the water sprinkler is activated by the smoke detector to sprinkle water outward automatically so as to extinguish the fires. However, the conventional fire apparatus fails when the smoke detector is inoperative, thereby causing danger to the user. In addition, the water sprinkler sprays water to the whole house so that the water will wet the electric appliances in the house, thereby easily causing an electric shock to the user. A conventional fire extinguisher can also to be used to extinguish the fires. However, the conventional fire extinguisher has a smaller volume and cannot extinguish the fires successively.

### BRIEF SUMMARY OF THE INVENTION

In accordance with the present invention, there is provided a fire apparatus, comprising a main body, a water tank mounted in the main body, a spray gun removably mounted on the main body, a hose having a first end connected with the water tank and a second end connected with the spray gun, a drive pump mounted on the main body and connected with the spray gun to pressurize the spray gun, a power source mounted on the main body, and a transmission unit mounted on the main body and connected between the power source and the drive pump so that the drive pump is driven by the power source through transmission of the transmission unit.

The primary objective of the present invention is to provide an atomized fire apparatus that is driven by a single power.

According to the primary advantage of the present invention, the drive pump is driven by a single power of the power source without needing aid of an external power supply, thereby facilitating the user operating the fire apparatus.

According to another advantage of the present invention, the spray gun injects atomized water or bubbles so as to extinguish the fires easily and quickly.

According to a further advantage of the present invention, the spray gun is portable and movable to extinguish immediately the fires at a determined location without wetting the other place in the house so as to prevent from causing damage to the electric appliances in the house.

According to a further advantage of the present invention, when the power source is disposed at a slow running state during a neutral position, the power of the power source is transmitted by the transmission unit to the drive pump so that the drive pump is driven to pressurize the water tank and the spray gun, and the spraying nozzle of the spray gun sprays atomized water or bubbles outward to extinguish the fire easily and quickly.

According to a further advantage of the present invention, the lamps of the illuminating unit are rotatable freely so as to provide an illuminating effect to the user.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a fire apparatus in accordance with the preferred embodiment of the present invention.

FIG. 2 is a locally perspective enlarged view of the fire apparatus as shown in FIG. 1.

FIG. 3 is anther perspective view of the fire apparatus as shown in FIG. 2.

FIG. 4 is a top view of the fire apparatus as shown in FIG. 2.

FIG. 5 is a schematic operational view of an illuminating unit of the fire apparatus as shown in FIG. 1 in use.

### DETAILED DESCRIPTION OF THE INVENTION

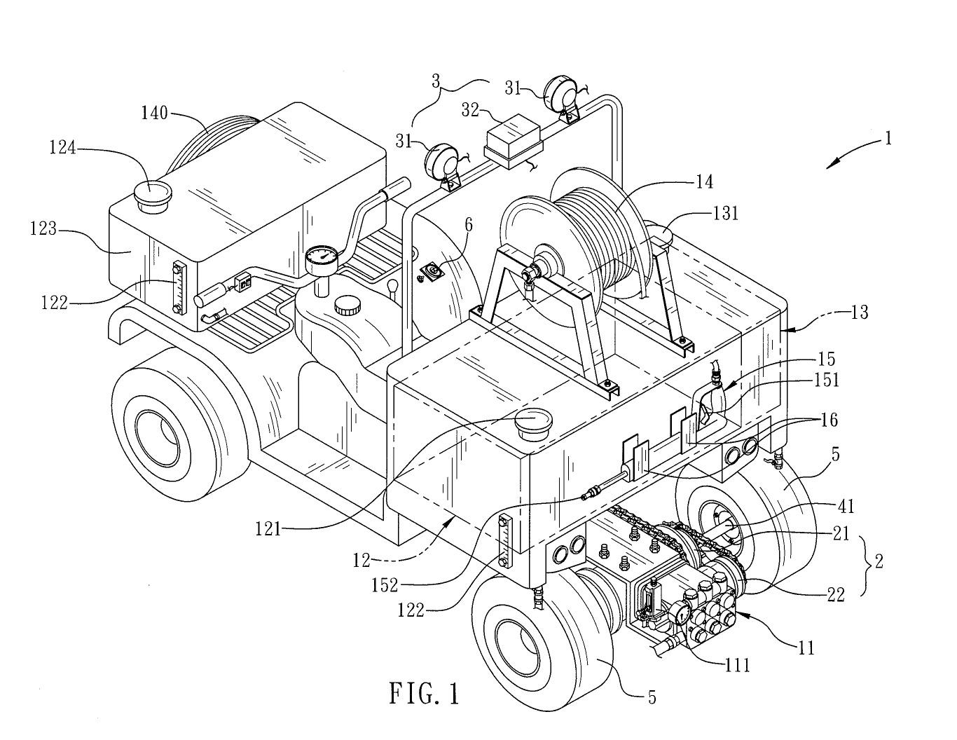

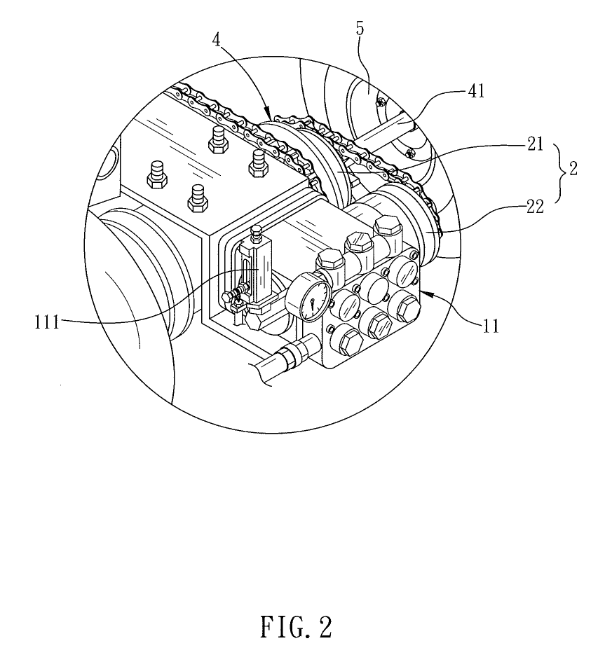

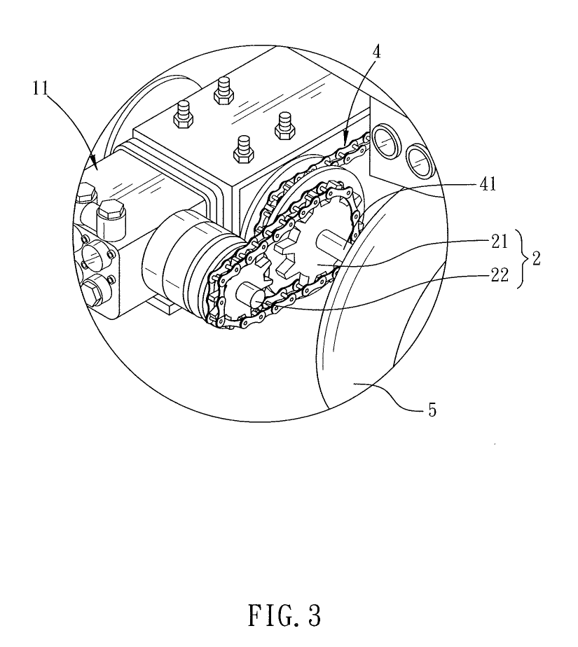

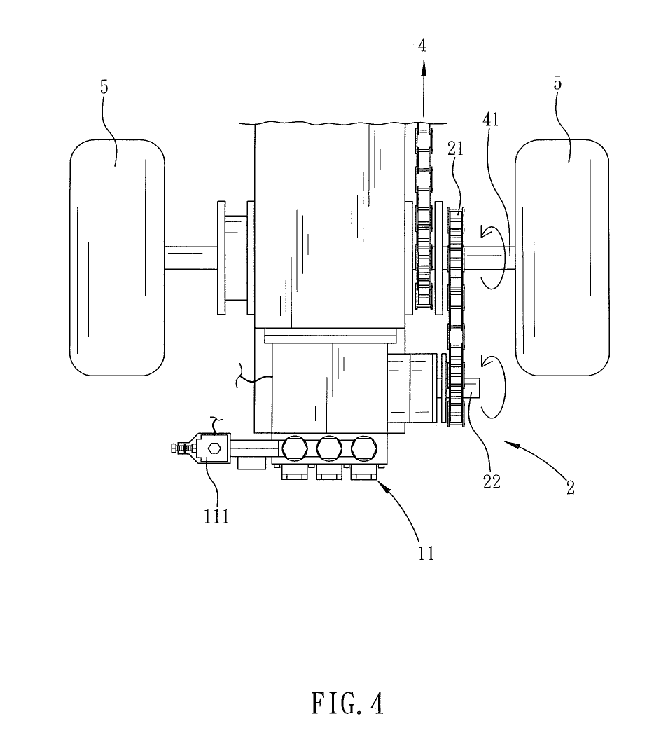

Referring to FIGS. 1-5, a fire apparatus in accordance with the preferred embodiment of the present invention comprises a main body 1, a water tank 12 mounted in the main body 1 and containing water therein, a spray gun 15 removably mounted on the main body 1, a support bracket 16 mounted on the main body 1 to support the spray gun 15, a hose 14 having a first end connected with the water tank 12 and a second end connected with the spray gun 15, a drive pump 11 mounted on the main body 1 and connected with the spray gun 15 to pressurize the spray gun 15, a power source 4 mounted on the main body 1, a transmission unit 2 mounted on the main body 1 and connected between the power source 4 and the drive pump 11 so that the drive pump 11 is driven by the power source 4 through transmission of the transmission unit 2, an illuminating unit 3 mounted on the main body 1 and connected with the power source 4, a spare water tank 123 mounted on a front end of the main body 1 and containing water therein, a spare hose 140 connected with the spare water tank 123, and a plurality of wheels 5 mounted on a bottom of the main body 1.

The fire apparatus further comprises a bubble tank 13 mounted in the main body 1 and containing bubbles therein, and the first end of the hose 14 is selectively connected with the bubble tank 13. The bubble tank 13 has a top provided with a bubble inlet port 131.

The water tank 12 has a top provided with a water inlet port 121. The spare water tank 123 has a top provided with a spare water inlet port 124. Each of the water tank 12 and the spare water tank 123 has a side provided with a level indicator 122 to indicate the water level of each of the water tank 12 and the spare water tank 123.

The hose 14 is mounted on the main body 1 and is extendable outward from the main body 1. The hose 14 is made of a material (such as stainless steel) that can withstand a weight of at least sixty kilograms (60 kg). The hose 14 has a length of about ten to thirty meters (10-30 m). The spare hose 140 has a first end connected with the spare water tank 123 and a second end connected with an external water source (not shown) to deliver spare water into the spare water tank 123.

The power source 4 includes a power output shaft 41. In the preferred embodiment of the present invention, the power source 4 is a car engine. The power output shaft 41 of the power source 4 is connected with the wheels 5 to rotate the wheels 5.

The transmission unit 2 includes a clutch 21 engaging the power output shaft 41 of the power source 4 and a power connection 22 engaging the clutch 21. The power connection 22 of the transmission unit 2 engages the drive pump 11. In the preferred embodiment of the present invention, the power connection 22 of the transmission unit 2 is a belt gear train or a sprocket train.

The fire apparatus further comprises a control switch 6 mounted on the main body 1 and connected with the power source 4 and the drive pump 11. In practice, when the control switch 6 is pressed, the power source 4 is disposed at a slow running state during a neutral position, and the drive pump 11 is started only when the power source 4 is disposed at a slow running state during a neutral position. Thus, when the power source 4 is disposed at a slow running state during a neutral position, the power output shaft 41 of the power source 4 drives the clutch 21 which drives the power connection 22 which drives the drive pump 11 so that the drive pump 11 is started to pressurize the water tank 12 and the hose 14 and to deliver the pressurized water in the water tank 12 through the hose 14 into the spray gun 15.

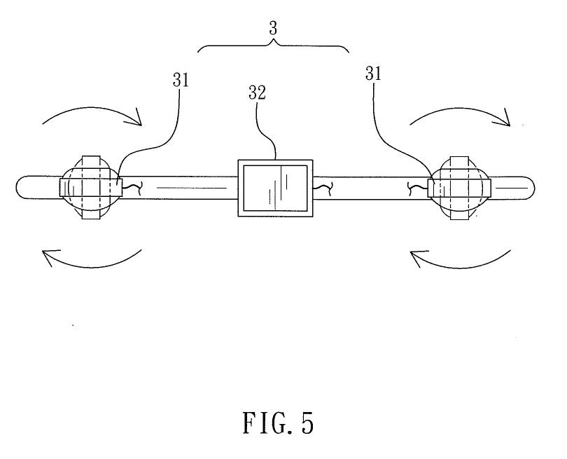

The illuminating unit 3 is mounted on the top of the main body 1 and is electrically connected with the power source 4 so that the electric power of the illuminating unit 3 is supplied by the power source 4. The illuminating unit 3 includes a plurality of lamps 31 and an alarm 32. The lamps 31 of the illuminating unit 3 are rotatable through three hundred and sixty degrees (360°) as shown in FIG. 5 to provide an illuminating effect to the user.

The spray gun 15 is removably mounted on the support bracket 16.

The spray gun 15 is provided with a trigger 151 and a spraying nozzle 152. The trigger 151 of the spray gun 15 is used to open or close the spray gun 15. The spraying nozzle 152 of the spray gun 15 is used to spray atomized liquid outward. Thus, the liquid contained in the spray gun 15 is pressurized by the drive pump 11 to form a high pressure liquid that is injected outward from the spraying nozzle 152 in an atomized manner.

The drive pump 11 is connected with the water tank 12 to pressurize the water tank 12 and the hose 14 and to deliver the pressurized water in the water tank 12 through the hose 14 into the spray gun 15. The drive pump 11 is selectively connected with the bubble tank 13 to pressurize the bubble tank 13 and the hose 14 and to deliver the pressurized bubbles in the bubble tank 13 through the hose 14 into the spray gun 15. The drive pump 11 is provided with an automatic speed controller 111. The automatic speed controller 111 of the drive pump 11 is connected with the trigger 151 of the spray gun 15 and is connected with the power source 4.

In practice, when the control switch 6 is pressed, the power source 4 is disposed at a slow running state during a neutral position, and the drive pump 11 is started to pressurize the water tank 12 and the hose 14 and to deliver the pressurized water in the water tank 12 through the hose 14 into the spray gun 15. In such a manner, when the trigger 151 of the spray gun 15 is pulled, the automatic speed controller 111 of the drive pump 11 is connected with the power source 4 so that the power source 4 is driven by the automatic speed controller 111 of the drive pump 11 to operate automatically at a higher speed to pressurize the water in the spray gun 15 to form a high pressure water. Thus, the high pressure water in the spray gun 15 is injected and sprayed outward from the spraying nozzle 152 of the spray gun 15 in an atomized manner so that the spraying nozzle 152 of the spray gun 15 sprays atomized water outward to extinguish the fire. On the contrary, when the trigger 151 of the spray gun 15 is released, the spray gun 15 stops spraying the atomized water, and the automatic speed controller 111 of the drive pump 11 stops operating. At this time, the power source 4 is still disposed at a slow running state during a neutral position.

In operation, when the power source 4 is disposed at a starting position, the power output shaft 41 of the power source 4 is connected with the wheels 5 to rotate the wheels 5. At this time, the clutch 21 of the transmission unit 2 disengages the power output shaft 41 of the power source 4 so that the power connection 22 of the transmission unit 2 is not driven by the clutch 21, and the drive pump 11 is inoperative.

On the contrary, when the control switch 6 is pressed, the power source 4 is disposed at a slow running state during a neutral position, and the drive pump 11 is started to pressurize the water tank 12 and the hose 14 and to deliver the pressurized water in the water tank 12 through the hose 14 into the spray gun 15. In such a manner, when the trigger 151 of the spray gun 15 is pulled, the automatic speed controller 111 of the drive pump 11 is connected with the power source 4 so that the power source 4 is driven by the automatic speed controller 111 of the drive pump 11 to operate automatically at a higher speed to pressurize the water in the spray gun 15 to form a high pressure water. Thus, the high pressure water in the spray gun 15 is injected and sprayed outward from the spraying nozzle 152 of the spray gun 15 in an atomized manner so that the spraying nozzle 152 of the spray gun 15 sprays atomized water outward to extinguish the fire.

Thus, when the trigger 151 of the spray gun 15 is pressed, the high pressure water in the spray gun 15 is injected and sprayed outward from the spraying nozzle 152 of the spray gun 15 in an atomized manner so as to extinguish the fires. At this time, the atomized water injected from the spray gun 15 has smaller size. Thus, when the atomized water touches the fires, the atomized water is heated and vaporized into vapors so that the whole volume of the vapors is expanded largely to isolate the oxygen in the air from the fires so as to extinguish the fires easily and quickly. In addition, the atomized water will not conduct the electricity to prevent from causing an electric shock to the user. Further, the spray gun 15 is movable to extinguish the fires at the determined location only without wetting the other place in the house to prevent from causing damage to the electric appliances in the house.

Accordingly, the spray gun 15 injects atomized water or bubbles so as to extinguish the fires easily and quickly. In addition, the spray gun 15 is portable and movable to extinguish immediately the fires at a determined location without wetting the other place in the house so as to prevent from causing damage to the electric appliances in the house. Further, when the power source 4 is disposed at a slow running state during a neutral position, the power of the power source 4 is transmitted by the transmission unit 2 to the drive pump 11 so that the drive pump 11 is driven to pressurize the water tank 12 and the spray gun 15, and the spraying nozzle 152 of the spray gun 15 sprays atomized water or bubbles outward to extinguish the fire easily and quickly. Further, the drive pump 11 is driven by a single power of the power source 4 without needing aid of an external power supply, thereby facilitating the user operating the fire apparatus. Further, the lamps 31 of the illuminating unit 3 are rotatable freely so as to provide an illuminating effect to the user.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A fire apparatus, comprising:
a main body;
a water tank mounted in the main body;
a spray gun removably mounted on the main body;
a hose having a first end connected with the water tank and a second end connected with the spray gun;
a drive pump mounted on the main body and connected with the spray gun to pressurize the spray gun;
a power source mounted on the main body; and
a transmission unit mounted on the main body and connected between the power source and the drive pump so that the drive pump is driven by the power source through transmission of the transmission unit.

2. The fire apparatus of claim 1, wherein
the power source includes a power output shaft;
the transmission unit includes:
a clutch engaging the power output shaft of the power source; and
a power connection engaging the clutch;
the power connection of the transmission unit engages the drive pump.

3. The fire apparatus of claim 2, wherein the spray gun is provided with a trigger and a spraying nozzle.

4. The fire apparatus of claim 3, wherein the drive pump is provided with an automatic speed controller;
the automatic speed controller of the drive pump is connected with the trigger of the spray gun and is connected with the power source.

5. The fire apparatus of claim 4, wherein the fire apparatus further comprises:
a control switch mounted on the main body and connected with the power source and the drive pump.

6. The fire apparatus of claim 1, wherein
the fire apparatus further comprises:
a support bracket mounted on the main body to support the spray gun;
the spray gun is removably mounted on the support bracket.

7. The fire apparatus of claim 1, wherein the fire apparatus further comprises:
an illuminating unit mounted on the main body and connected with the power source.

8. The fire apparatus of claim 7, wherein the illuminating unit is mounted on a top of the main body and is electrically connected with the power source so that the electric power of the illuminating unit is supplied by the power source.

9. The fire apparatus of claim 7, wherein the illuminating unit includes a plurality of lamps which are rotatable through three hundred and sixty degrees (360°).

10. The fire apparatus of claim 1, wherein the fire apparatus further comprises:
a spare water tank mounted on a front end of the main body and containing water therein;
a spare hose connected with the spare water tank.

11. The fire apparatus of claim 1, wherein
the fire apparatus further comprises:
a bubble tank mounted in the main body;
the first end of the hose is selectively connected with the bubble tank.

12. The fire apparatus of claim 1, wherein the hose is mounted on the main body and is extendable outward from the main body.

13. The fire apparatus of claim 2, wherein the power source is a car engine.

14. The fire apparatus of claim 2, wherein the power connection of the transmission unit is a belt gear train or a sprocket train.

15. The fire apparatus of claim 2, wherein
the drive pump is connected with the water tank to pressurize the water tank and the hose and to deliver the pressurized water in the water tank through the hose into the spray gun;
the power output shaft of the power source drives the clutch which drives the power connection which drives the drive pump so that the drive pump is started to pressurize the water tank and the hose.

16. The fire apparatus of claim 11, wherein the drive pump is selectively connected with the bubble tank to pressurize the bubble tank and the hose.

17. The fire apparatus of claim 2, wherein
the fire apparatus further comprises:
a plurality of wheels mounted on a bottom of the main body;
the power output shaft of the power source is connected with the wheels to rotate the wheels.
